(19) United States
(12) Patent Application Publication
(10) Pub. No.: US 2015/0160805 A1
(43) Pub. Date: Jun. 11, 2015

(54) Electronic Reading Device and Method Therefor

(71) Applicants: Ahmed Ali, Doha (QA); Stephan Vogel, Doha (QA)

(72) Inventors: Ahmed Ali, Doha (QA); Stephan Vogel, Doha (QA)

(73) Assignee: QATAR FOUNDATION, Doha (QA)

(21) Appl. No.: 14/407,391

(22) PCT Filed: Jun. 13, 2012
(86) PCT No.: PCT/EP2012/061171

§ 371 Date: Feb. 18, 2015

(51) Int. Cl. G06F 3/0483; G06F 3/0484

(52) U.S. Cl. CPC G06F 3/0483; G06F 3/04842

(57) ABSTRACT

An electronic reading device or e-reader comprises a display (9), a user interface (10), a reading direction discriminator (11) and a memory (8) which are each connected to a processor (7). The reading direction discriminator (11) is operable to determine a reading directionality of a writing system employed in a publication stored in the memory (8). The processor (7) is operable to receive a user input request via the user interface (10) and, in response to the user input request and the reading directionality, to provide a page turn instruction and display the related page of the publication. The e-reader is thus operable to detect whether the writing system used in an electronic publication is a left to right or right to left writing system and to provide the correct next page or previous page in response to a page turn request.

### DESCRIPTION OF INVENTION

This invention relates to an electronic reading device (an e-reader) and more particularly to an electronic reading device which displays the pages of a publication in the correct order for the writing system employed in the publication.

The invention also relates to a method of using an electronic reading device.

### BACKGROUND

A standard e-book reading format (.epub) is becoming a worldwide standard for digital books or e-reader systems. .epub uses three mandatory metadata tags, one of which determines the language in which the text should be displayed. Most particularly, the .epub format is concerned with correctly displaying the content text on a number of different e-readers so that the displayed text is optimised for a particular display device. Details of the .epub file format can be found at www.idpf.orq (International digital publishing forum). As such .epub documents have a dynamic layout and are intended to be formatted on a respective device on the fly rather than being typeset into particularly sized pages and are thus able to be rendered onto different size device screens or window sizes and orientations.

Almost all publications have a contents page which identifies the introduction and usually numbered paragraphs indicating a start page for a particular chapter and optionally an end page. Some publications also include an index indicating where indexed terms can be identified on respective pages in the publication.

Other reading format standards are available but because the text content can be displayed on a number of different devices, the content is formatted and paginated dynamically rather than being forced into a particular static page and display size.

All writing systems are directional with the majority of writing systems running left to right and top to bottom. Some writing systems, particularly Aramaic writing systems and Aramaic-derived writing systems such as Farsi and Urdu, read from right to left and top to bottom. Mongolian reads top to bottom and then right to left. Some writing systems are bi-directional.

Fixed format or static format documents can be prepared and published using various typesetting solutions. Existing technologies are available to identify a language or writing system from metadata tags applied to content to ensure that the text content is correctly typeset in a left to right or right to left direction as dictated by the writing system identifier in the metadata tag.

Arabtex is a software package which provides an open source typesetting solution using metadata tags to determine directionality of a writing system and to incorporate text into fixed format documents in either left to right direction or right to left direction. Arabtex is limited to providing typesetting solutions for static presentation methods such as typesetting or preparing pages of the file to be sent to a printer.

The present invention seeks to provide an improved electronic reading device and method.

According to one aspect of the present invention, there is provided an electronic reading device for displaying multiple pages of an electronic publication and for moving from a present page to a next page or a previous page in response to a user input, the system comprising: a display operable to display one or more pages of the publication; a user interface operable to receive a user input request from a user and provide the user input request to a processor; and a reading direction discriminator operable to provide a determined reading directionality of a writing system employed in the publication to the processor; the processor being operable to receive the user input request and the determined reading directionality and, in response to the user input request and the reading directionality, provide a page turn instruction and display the page requested by the user in accordance with the reading directionality of the writing system employed in the publication.

Preferably the user input request comprises a next page request or a previous page request.

Conveniently the reading direction discriminator is operable to provide the determined reading directionality of the writing system employed in the publication based on an automatic detection of writing system employed in the publication.

Advantageously the reading direction discriminator is operable to detect the writing system by recognising the language of words used in the publication.

Preferably the reading direction discriminator is operable to detect the writing system by recognising the alphabet used in the writing system.

Conveniently the reading direction discriminator is operable to provide the determined reading directionality of the writing system employed in the publication based on a metadata tag attached to the publication.

Advantageously the user interface comprises at least one button.

Preferably the user interface comprises a touchscreen, touchpad, trackpad or mouse.

Conveniently the user input request is a directional gesture on the touchscreen, touchpad, trackpad or mouse.

Advantageously a right to left gesture is a next page user input request for a determined left to right reading directionality.

Preferably a left to right gesture is a previous page user input request for a left to right reading directionality.

Conveniently, a left to right gesture is a next page user input request for a right to left reading directionality.

Advantageously a right to left gesture is a previous page user input request for a right to left reading directionality.

Preferably the user interface comprises a touchscreen and a first portion of the touchscreen is operable to receive a touch input indicative of a next page user request and another portion of the touchscreen is operable to receive a touch input indicative of a previous page input request.

Conveniently, the user interface comprises at least two buttons which are each remote from the display.

Advantageously the reading direction discriminator is operable to determine the reading directionality of a writing system employed only on the page presently shown on the display.

Preferably the reading direction discriminator is operable to determine the reading directionality of multiple pages in the publication.

Conveniently the user interface is operable to receive a user input which is a user gesture, the gesture having a component of direction which is substantially parallel to the reading direction of the writing system employed in the publication.

Advantageously the device further comprises a graphics controller which is operable to render an animated page turn consistent with the user input request.

According to another aspect of the present invention, there is provided, a method for displaying multiple pages of an electronic publication and for moving from a present page to a next page or a previous page in response to a user input, the method comprising: displaying a present page of a publication on a display; receiving a user input request from a user via a user interface and providing the user input request to a processor; analysing the page or publication using a reading direction discriminator to determine a reading directionality of a writing system employed in the publication and providing the determined reading directionality to the processor; processing the user input request and the determined reading directionality and, in response to the user input request and the reading directionality, providing a page turn instruction and displaying the page requested by the user in accordance with the reading directionality of the writing system employed in the publication.

Preferably the user input request comprises a next page request or a previous page request.

Conveniently the reading direction discriminator analyses the publication to determine a reading directionality of a writing system employed in the publication by automatically detecting the writing system employed in the publication.

Advantageously the reading direction discriminator automatically detects the writing system by recognising the language of words used in the publication.

Preferably the reading direction discriminator detects the writing system by recognising the alphabet used in the writing system.

Conveniently the reading direction discriminator determines the reading directionality of the writing system employed in the publication using a metadata tag attached to the publication.

Advantageously the user interface comprises at least one button and the step of receiving a user input request comprises activating the at least one button.

Preferably the user interface comprises a touchscreen, touchpad, trackpad or mouse and the step of receiving a user input request comprises activating the touchscreen, touchpad, trackpad or mouse.

Conveniently the step of receiving a user input request comprises receiving a directional gesture on the touchscreen, touchpad, trackpad or mouse.

Advantageously a right to left gesture is a next page user input request for a determined left to right reading directionality.

Preferably a left to right gesture is a previous page user input request for a left to right reading directionality.

Conveniently a left to right gesture is a next page user input request for a right to left reading directionality.

Advantageously a right to left gesture is a previous page user input request for a right to left reading directionality.

Preferably the user interface comprises a touch screen and the step of receiving a user input request comprises detecting a touch input on a first portion of the touchscreen to indicate a next page user request and detecting a touch input on another portion of the touchscreen to indicate a previous page input request.

Conveniently the user interface comprises at least two buttons which are each remote from the display.

Advantageously the reading direction discriminator determines the reading directionality of a writing system employed only on the page presently shown on the display.

Preferably the reading direction discriminator determines the reading directionality of multiple pages in the publication.

Conveniently the step of receiving a user input request comprises receiving a user gesture input, the gesture input having a component of a direction which is substantially parallel to the reading direction of the writing system employed in the publication.

Advantageously the method further comprises rendering an animated page turn consistent with the user input request.

In order that the invention may be more readily understood, embodiments thereof will now be described, by way of example, with reference to the accompanying drawings in which:

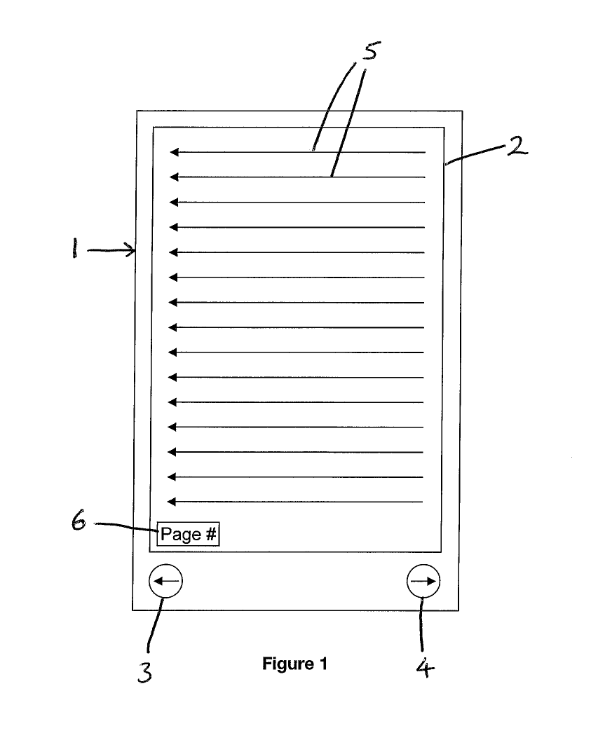

FIG. 1 is a schematic diagram of an electronic reading device (e-reader) displaying a page of a publication in a right to left writing system;

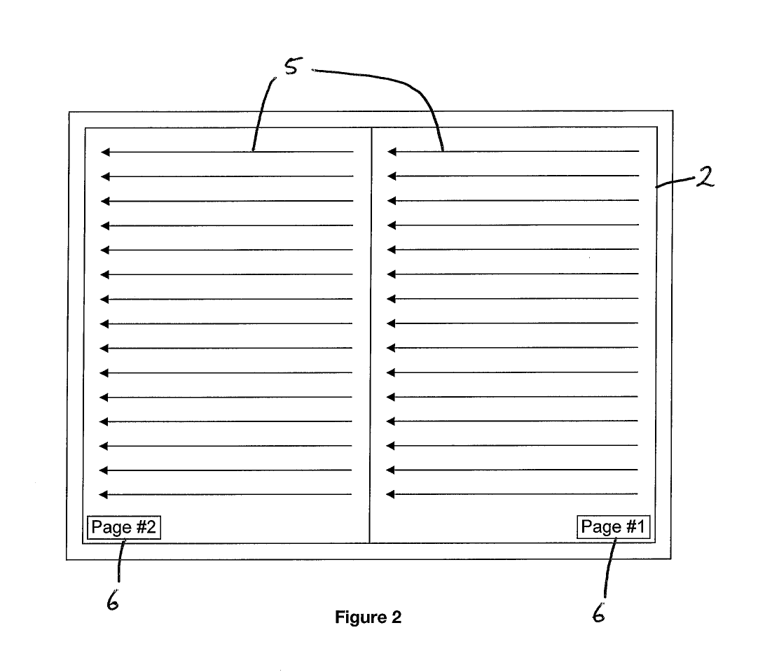

FIG. 2 is a schematic diagram of an e-reader displaying two pages of a publication in a right to left writing system;

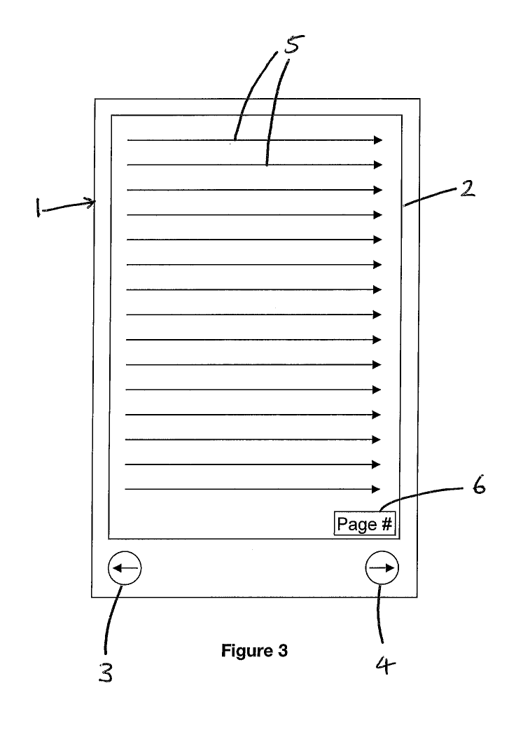

FIG. 3 is a schematic diagram of an e-reader displaying a page of a publication in a left to right writing system;

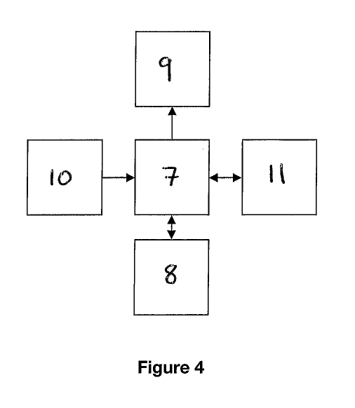

FIG. 4 is a schematic diagram of an electronic reading system of an embodiment of the invention; and

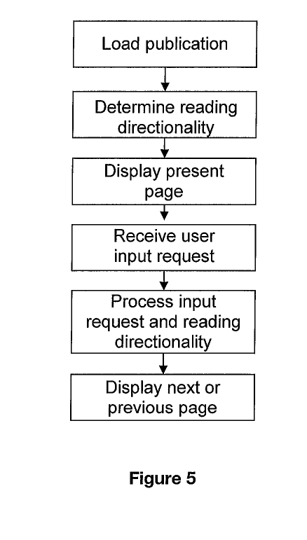

FIG. 5 is a flow diagram showing a process embodying the present invention.

Referring initially to FIG. 1, an electronic reading device referred to hereafter as an e-reader 1 incorporates a display 2 and a user interface in the form of page turn buttons 3, 4.

An e-reader of an embodiment of the invention has a user interface that may incorporate a greater or fewer number of buttons than the e-reader shown in FIG. 1 and the buttons may be positioned anywhere on the e-reader. In further embodiments, the display 2 is a touchscreen display which receives user input. In one embodiment, the touchscreen is the only user interface input device and in other embodiments, the touchscreen is provided in connection with other user input devices, such as buttons, cameras, microphones or other sensors.

In FIG. 1, lines of text 5 are represented on the display 2. The arrowhead on each line of text 5 represents the reading directionality of the writing system employed on the page. In this example, the reading directionality is right to left. Therefore, the writing system may, for example, be an Aramaic writing system or an Aramaic-derived writing system such as Farsi or Urdu.

The correct positioning of the page number for a page showing a right to left reading directionality writing system is on the left-hand side of the page, as represented by the page number marker 6. The page number marker 6 is positioned on the left-hand side of the page since, in a conventional book, a user would lift the left-hand side of the page to turn or flip the page from left to right to move on to the next page in the book. The page number is preferably displayed using the numbering system of the writing system employed in the publication.

FIG. 2 shows an e-reader incorporating a display 2 which displays two pages of a publication side by side in a landscape format. The pages include lines of text 5 which employ a right to left reading directionality. In this landscape format, the page number markers 6 appear on the outside edges of the left and right pages, as shown in FIG. 2. Since the writing system of the lines of text 5 has a right to left reading directionality, the page number shown on the left hand page is higher than the page number shown on the right hand page.

For a publication employing a writing system with a left to right reading directionality, page numbers are also shown on the outside edges of the left and right pages when the publication is viewed in landscape format. However, for a left to right reading directionality, the page number shown on the right hand page is higher than the page number shown on the left hand page.

FIG. 3 shows another example in which the e-reader 1 shows lines of text 5 of a writing system having a left to right reading directionality. As before, the arrowheads on the lines of text 5 indicate the reading direction of the writing system which, in this case, is left to right.

The page number marker on a page showing text of a writing system having a left to right reading directionality is on the right-hand side of the page, as shown in FIG. 3.

Referring now to FIG. 4, an electronic reading device or e-reader of a preferred embodiment of the invention incorporates a processor 7, a memory 8 and a display 9. The memory 8 is configured to store an electronic publication, such as an e-book, magazine or newspaper. The processor 7 is operable to retrieve data representing a page of the publication from the memory 8 and to transmit the data to the display 9 to display the page to a user.

The publication is preferably in a standard e-book reading format, such as .epub. However, the publication could be stored in any other file format, such as plain text, Microsoft Word or Adobe PDF. The publication may, or may not be protected with a form of digital rights management (DRM) protection.

The e-reader also incorporates a user interface 10 which is operable to receive a user input request and to provide the user input request to the processor 7.

In one embodiment, the user interface comprises physical buttons. In another embodiment, the user interface 10 incorporates a touchscreen instead of or in addition to physical buttons. In further embodiments, the e-reader incorporates other user interface sensors, such as a microphone or camera.

The e-reader further incorporates a reading direction discriminator 11 which is connected to the processor 7. In other embodiments, the reading direction discriminator 11 is implemented within the processor 7.

The reading direction discriminator 11 is operable to analyse the text of a publication stored in the memory 8 to determine the reading directionality of a writing system employed in the publication or in a page of the publication. The reading direction discriminator preferably determines the language and content of the body of text on a page using language and writing system identification techniques. Such techniques are familiar to a person skilled in the art. The identification could, for instance, be conducted by analysing words from the body of text and comparing them with words stored in multiple text repositories, each storing text of a known language, until a match with a known language is found. In other embodiments, the identification techniques identify font, script or the alphabet used in the body of text to determine whether the writing system is a right to left or left to right writing system.

In further embodiments, the reading direction discriminator 11 or the processor 7 is operable to read one or more metadata tags embedded in the electronic publication or page which indicate the language and/or writing system used in the publication or page. The presence of metadata tags in an electronic publication is, however, not required for the operation of embodiments of the invention. If an electronic publication includes metadata tags that assist in the detection of the writing system used in the publication then the metadata tags are used. If there are no metadata tags present that are indicative of the writing system used in a publication, embodiments of the invention automatically detect the language/script/writing system used in the publication without using any metadata tag information.

A method of using the e-reader will now be described with reference to FIG. 5.

The processor 7 receives a reading directionality indicator from the reading direction discriminator 11 and also receives a user input request from the user interface 10. When the processor 7 receives the reading directionality indicator, the processor 7 positions the page number on the page in the appropriate position according to the reading directionality of the writing system employed on the page. For instance, if the determined reading directionality is left to right then the page number indicator is positioned on the left-hand side of the page, as shown in FIG. 1. If, on the other hand, the determined reading directionality is left to right then the page number indicator is positioned on the right-hand side of the screen as shown in FIG. 3. The e-reader therefore positions the page number indicator in the correct position on the page according to the detected reading directionality of the writing system employed on the page.

If the e-reader is configured to display two pages of the publication in landscape format, the e-reader positions the page numbers on the outside edges of the left and right pages, as shown in FIG. 2. If the detected reading directionality is right to left, the e-reader ensures that the page number shown on the left hand page is higher than the page number shown on the right hand page. If, on the other hand, the detected reading directionality is left to right, the e-reader ensures that the page number shown on the right hand page is higher than the page number shown on the left hand page.

The e-reader is operable to display each page number using the numbering system of the writing system of the publication. For instance, the page numbers are shown in Arabic if the writing system of the publication is Arabic.

The determined reading directionality is also indicative of the page turn direction of the publication. If the reading direction discriminator 11 detects that a publication employs a writing system with a right to left reading directionality then the e-reader registers that the page turn direction to move to the next page is left to right. Conversely, for a writing system with a left to right reading directionality, the page turn direction for the next page is right to left.

The user interface 10 is operable to receive user input indicating a left to right or a right to left page turn. In embodiments in which the user interface incorporates physical buttons, such as the buttons 3, 4 shown in FIGS. 1 and 3, a left to right page turn request is input by a user pressing the button 4 on the right-hand side of the device. Conversely, a right to left page turn request is input by the user pressing the button 3 on the left-hand side of the device. For embodiments incorporating a touchscreen, the page turn request is input by a user touching a portion of the screen. For instance, a user can touch a left-hand portion of the screen to input a left to right page turn request or the user can touch a right-hand portion of the screen to input a right to left page turn request.

In other embodiments, the e-reader incorporates a touchscreen and the e-reader is operable to respond to gestures made by a user touching the screen. In these embodiments, a user can input a left to right page turn request by touching and swiping across the screen from left to right. Conversely, the user can input a right to left page turn request by touching and swiping from right to left across the screen.

When the processor 7 receives a page turn request from the user interface 10, the processor 7 processes the page turn request in combination with the determined reading directionality to determine the next page of the publication that should be displayed on the display 9. If the determined reading directionality is left to right and the page turn request is a left to right page turn request then the processor determines that the next page in the publication should be displayed on the display 9. Conversely, if the determined reading directionality is left to right and the user input request is a right to left input request then the processor determines that the previous page in the publication should be displayed on the display 9.

The e-reader is also operable to display the table of contents of a publication in a position on the page which is appropriate to the reading directionality of the writing system employed in the publication. For instance, in a right to left reading directionality writing system, the table of contents is aligned to the right of the page. Conversely, in a left to right reading directionality writing system, the table of contents is aligned to the left of the page.

An e-reader of an embodiment of the invention is also operable to select a number system for the displayed table of contents which is appropriate to the detected writing system employed in the publication.

In other embodiments of the invention, the e-reader is operable to determine top to bottom and bottom to top reading directionality in addition to or instead of determining left to right and right to left reading directionality. In these embodiments, the page number indicator and the table of contents are aligned automatically by the e-reader in the correct position on the page according to the writing system.

In other embodiments of the invention, the e-reader is operable to display the content of the publication in a font appropriate to the writing system automatically in response to the detected writing system employed in the publication.

When used in this specification and claims, the terms “comprises” and “comprising” and variations thereof mean that the specified features, steps or integers are included. The terms are not to be interpreted to exclude the presence of other features, steps or components.

1. An electronic reading device for displaying multiple pages of an electronic publication and for moving from a present page to a next page or a previous page in response to a user input, the system comprising:
a display operable to display one or more pages of the publication;
a user interface operable to receive a user input request from a user and provide the user input request to a processor; and
a reading direction discriminator operable to provide a determined reading directionality of a writing system employed in the publication to the processor; the processor being operable to receive the user input request and the determined reading directionality and, in response to the user input request and the reading directionality, provide a page turn instruction and display the page requested by the user in accordance with the reading directionality of the writing system employed in the publication.

2. An electronic reading device according to claim 1, wherein the user input request comprises a next page request or a previous page request.

3. An electronic reading device according to claim 1 or claim 2, wherein the reading direction discriminator is operable to provide the determined reading directionality of the writing system employed in the publication based on an automatic detection of writing system employed in the publication.

4. An electronic reading device according to claim 3, wherein the reading direction discriminator is operable to detect the writing system by recognising the language of words used in the publication.

5. An electronic reading device according to claim 3 and claim 4, wherein the reading direction discriminator is operable to detect the writing system by recognising the alphabet used in the writing system.

6. An electronic reading device according to any one of the preceding claims, wherein the reading direction discriminator is operable to provide the determined reading directionality of the writing system employed in the publication based on a metadata tag attached to the publication.

7. An electronic reading device according to any one of the preceding claims, wherein the user interface comprises at least one button.

8. An electronic reading device according to any of the preceding claims, wherein the user interface comprises a touchscreen, touchpad, trackpad or mouse.

9. An electronic reading device according to claim 8, wherein the user input request is a directional gesture on the touchscreen, touchpad, trackpad or mouse.

10. An electronic reading device according to claim 9, wherein a right to left gesture is a next page user input request for a determined left to right reading directionality.

11. An electronic reading device according to claim 9, wherein a left to right gesture is a previous page user input request for a left to right reading directionality.

12. An electronic reading device according to claim 9, wherein a left to right gesture is a next page user input request for a right to left reading directionality.

13. An electronic reading device according to claim 9, wherein a right to left gesture is a previous page user input request for a right to left reading directionality.

14. An electronic reading device according to any one of the preceding claims, wherein the user interface comprises a touchscreen and a first portion of the touchscreen is operable to receive a touch input indicative of a next page user request and another portion of the touchscreen is operable to receive a touch input indicative of a previous page input request.

15. An electronic reading device according to any one of the preceding claims, wherein the user interface comprises at least two buttons which are each remote from the display.

16. An electronic reading device according to any one of the preceding claims, wherein the reading direction discriminator is operable to determine the reading directionality of a writing system employed only on the page presently shown on the display.

17. An electronic reading device according to any one of claims 1 to 15, wherein the reading direction discriminator is operable to determine the reading directionality of multiple pages in the publication.

18. An electronic reading device according to any one of the preceding claims, wherein the user interface is operable to receive a user input which is a user gesture, the gesture having a component of direction which is substantially parallel to the reading direction of the writing system employed in the publication.

19. An electronic reading device according to any one of the preceding claims, wherein the device further comprises a graphics controller which is operable to render an animated page turn consistent with the user input request.

20. A method for displaying multiple pages of an electronic publication and for moving from a present page to a next page or a previous page in response to a user input, the method comprising:
displaying a present page of a publication on a display;
receiving a user input request from a user via a user interface and providing the user input request to a processor;
analysing the publication using a reading direction discriminator to determine a reading directionality of a writing system employed in the publication and providing the determined reading directionality to the processor;
processing the user input request and the determined reading directionality and, in response to the user input request and the reading directionality, providing a page turn instruction and displaying the page requested by the user in accordance with the reading directionality of the writing system employed in the publication.

21. A method according to claim 20, wherein the user input request comprises a next page request or a previous page request.

22. A method according to claim 20 or claim 21, wherein the reading direction discriminator analyses the publication to determine a reading directionality of a writing system employed in the publication by automatically detecting the writing system employed in the publication.

23. A method according to claim 22, wherein the reading direction discriminator automatically detects the writing system by recognising the language of words used in the publication.

24. A method according to claim 22 or claim 23, wherein the reading direction discriminator detects the writing system by recognising the alphabet used in the writing system.

25. A method according to any one of claims 20 to 24, wherein the reading direction discriminator determines the reading directionality of the writing system employed in the publication using a metadata tag attached to the publication.

26. A method according to any one claims 20 to 25, wherein the user interface comprises at least one button and the step of receiving a user input request comprises activating the at least one button.

27. A method according to any one of claims 20 to 26, wherein the user interface comprises a touchscreen, touchpad, trackpad or mouse and the step of receiving a user input request comprises activating the touchscreen, touchpad, trackpad or mouse.

28. A method according to claim 27, wherein the step of receiving a user input request comprises receiving a directional gesture on the touchscreen, touchpad, trackpad or mouse.

29. A method according to claim 28, wherein a right to left gesture is a next page user input request for a determined left to right reading directionality.

30. A method according to claim 28, wherein a left to right gesture is a previous page user input request for a left to right reading directionality.

31. A method according to claim 28, wherein a left to right gesture is a next page user input request for a right to left reading directionality.

32. A method according to claim 28, wherein a right to left gesture is a previous page user input request for a right to left reading directionality.

33. A method according to any one of claims 20 to 32, wherein the user interface comprises a touch screen and the step of receiving a user input request comprises detecting a touch input on a first portion of the touchscreen to indicate a next page user request and detecting a touch input on another portion of the touchscreen to indicate a previous page input request.

34. A method according to any one of claims 20 to 33, wherein the user interface comprises at least two buttons which are each remote from the display.

35. A method according to any one of claims 20 to 34, wherein the reading direction discriminator determines the reading directionality of a writing system employed only on the page presently shown on the display.

36. A method according to any one of claims 20 to 34, wherein the reading direction discriminator determines the reading directionality of multiple pages in the publication.

37. A method according to any one of claims 20 to 36, wherein the step of receiving a user input request comprises receiving a user gesture input, the gesture input having a component of a direction which is substantially parallel to the reading direction of the writing system employed in the publication.

38. A method according to any one of claims 20 to 37, wherein the method further comprises rendering an animated page turn consistent with the user input request.
